(19) United States
(12) Patent Application Publication
(10) Pub. No.: US 2026/0261146 A1
(43) Pub. Date: Sep. 3, 2026

(54) TRANSMISSION REQUIREMENTS OF AMBIENT DEVICES IN A WIRELESS COMMUNICATION NETWORK

(71) Applicant: Lenovo (Singapore) Pte. Ltd., Singapore (SG)

(72) Inventors: Apostolis SALKINTZIS, Athens (GR); Dimitrios DIMOPOULOS, Chalandri (GR)

(21) Appl. No.: 19/155,690

(22) PCT Filed: Mar. 23, 2023
(86) PCT No.: PCT/EP2023/057552

§ 371 Date: Aug. 12, 2025

(30) Foreign Application Priority Data
Feb. 17, 2023 (GR) 20230100131

(51) Int. Cl. H02J 50/00; H04W 8/24

(52) U.S. Cl. CPC H02J 50/001; H04W 8/24

(57) ABSTRACT

There is further provided a method in a first network node, the method comprising: receiving a plurality of uplink messages from an ambient IoT device; and determining whether the rate of receipt of messages from the ambient IoT device is within a preferred threshold range. The method further comprises determining energy parameters for a base station that serves the ambient IoT device, the energy parameters determined for optimizing energy harvesting by the ambient IoT device, wherein a measure of the energy harvesting by the ambient IoT device is given by the determination as to whether the rate of receipt of messages from the ambient IoT device is within the preferred threshold range; and sending an energy configuration message to the base station, the energy configuration message comprising the determined energy parameters.

### FIELD

The subject matter disclosed herein relates generally to the field of implementing managing transmission requirements of ambient devices in a wireless communication network. This document defines a first network node for wireless communication, a method in a first network node, a base station for wireless communication, and a method in a base station in a wireless communication network.

### INTRODUCTION

The “Ambient power-enabled Internet of Things” may comprise “ambient IoT” devices that are able to communicate with mobile networks, such as legacy wireless communication networks, 5G networks and beyond. An “ambient IoT” device is an Internet of Things (IoT) device powered by harvesting energy, such as RF energy, solar energy, wind energy, etc. An ambient IoT device may be battery-less and may have limited energy storage capability (e.g., using an internal capacitor).

RF energy harvesting enables wireless IoT devices to harvest energy from RF signals available in their environment, such as RF signals transmitted from mobile networks or from nearby Wi-Fi networks. RF energy harvesting is a technology that enables self-sustainable wireless IoT networks.

### SUMMARY

It is anticipated that certain research challenges will need to be addressed to enable the large-scale deployment of energy harvesting solutions for IOT environments. There are presented herein new ways to enhance 5G networks for supporting such IoT devices.

Disclosed herein are procedures for managing transmission requirements of ambient devices in a wireless communication network. Said procedures may be implemented by a first network node for wireless communication, a method in a first network node, a base station for wireless communication, and a method in a base station in a wireless communication network.

Accordingly, there is provided a first network node for wireless communication, comprising a processor; and a memory coupled with the processor. The processor is configured to cause the first network node to: receive a plurality of uplink messages from an ambient IoT device; and determine whether the rate of receipt of messages from the ambient IoT device is within a preferred threshold range. The processor is further configured to cause the first network node to: determine energy parameters for a base station that serves the ambient IoT device, the energy parameters determined for optimizing energy harvesting by the ambient IoT device, wherein a measure of the energy harvesting by the ambient IoT device is given by the determination as to whether the rate of receipt of messages from the ambient IoT device is within the preferred threshold range; and send an energy configuration message to the base station, the energy configuration message comprising the determined energy parameters.

There is further provided a method in a first network node, the method comprising: receiving a plurality of uplink messages from an ambient IoT device; and determining whether the rate of receipt of messages from the ambient IoT device is within a preferred threshold range. The method further comprises determining energy parameters for a base station that serves the ambient IoT device, the energy parameters determined for optimizing energy harvesting by the ambient IoT device, wherein a measure of the energy harvesting by the ambient IoT device is given by the determination as to whether the rate of receipt of messages from the ambient IoT device is within the preferred threshold range; and sending an energy configuration message to the base station, the energy configuration message comprising the determined energy parameters.

There is further provided a base station for wireless communication, comprising a processor, and a memory coupled with the processor. The processor is configured to cause the base station to: receive a plurality of uplink messages from an ambient IoT device; and send the plurality of uplink messages to a first network node in the wireless communication network. The processor is further configured to cause the base station to: receive an energy configuration message from the first network node, the energy configuration message comprising at least one energy parameter; and transmit radio frequency signals in accordance with the at least one energy parameter, the radio frequency signals transmitted to supply energy to the ambient IoT device.

There is further provided a method in a base station in a wireless communication network, the method comprising: receiving a plurality of uplink messages from an ambient IoT device; and sending the plurality of uplink messages to a first network node in the wireless communication network. The method further comprises receiving an energy configuration message from the first network node, the energy configuration message comprising at least one energy parameter; and transmitting radio frequency signals in accordance with the at least one energy parameter, the radio frequency signals transmitted to supply energy to the ambient IoT device.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for managing transmission requirements of ambient devices in a wireless communication network will now be described, by way of example only, with reference to the accompanying drawings, in which:

FIG. 1 depicts an embodiment of a wireless communication system for managing transmission requirements of ambient devices in a wireless communication network;

FIG. 2 depicts a user equipment apparatus that may be used for implementing the methods described herein;

FIG. 3 depicts further details of the network node that may be used for implementing the methods described herein;

FIG. 4 illustrates a system comprising a wireless communication network that includes a plurality of ambient IoT devices;

FIG. 5 illustrates a method for onboarding an ambient IoT device;

FIG. 6 illustrates a method for managing transmission requirements of an ambient IoT device;

FIG. 7 illustrates a method in a first network node; and

FIG. 8 illustrates a method in a base station in a wireless communication network.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

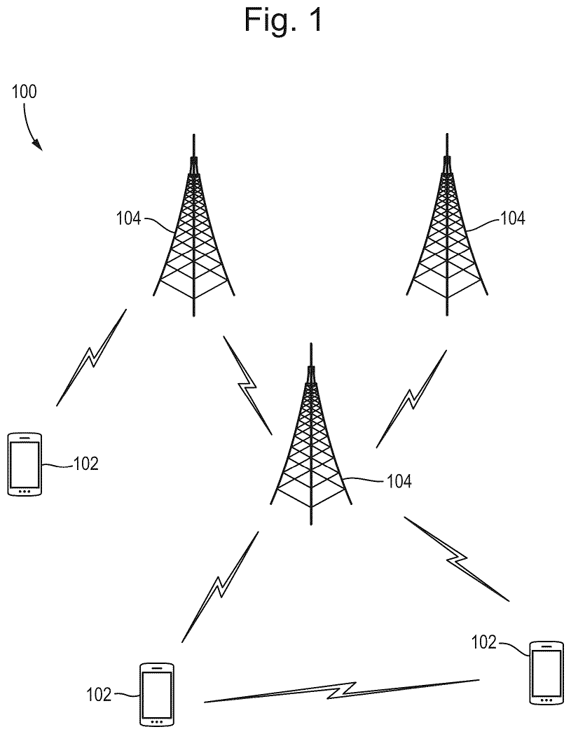

FIG. 1 depicts an embodiment of a wireless communication system 100 for managing transmission requirements of ambient devices in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

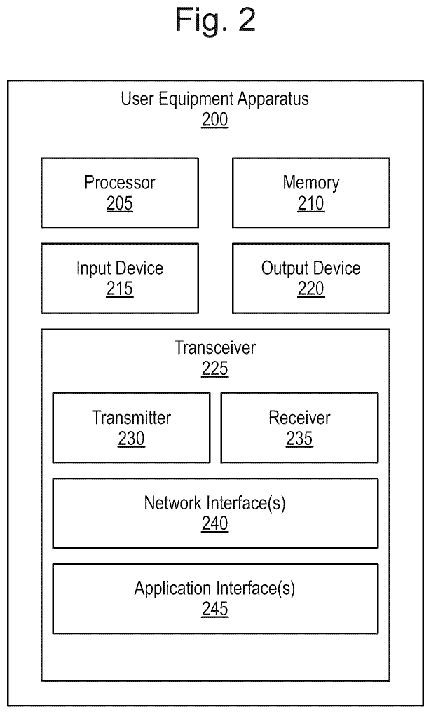

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102, or an ambient IoT device 405, 505 or 605 as described herein. The user equipment apparatus 200 includes a processor 205, a memory 210, and a transceiver 225; and may include an input device 215 and an output device 220. Where the user equipment apparatus 200 is an ambient IoT device, the user equipment apparatus 200 may not include an input device 215 and an output device 220.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

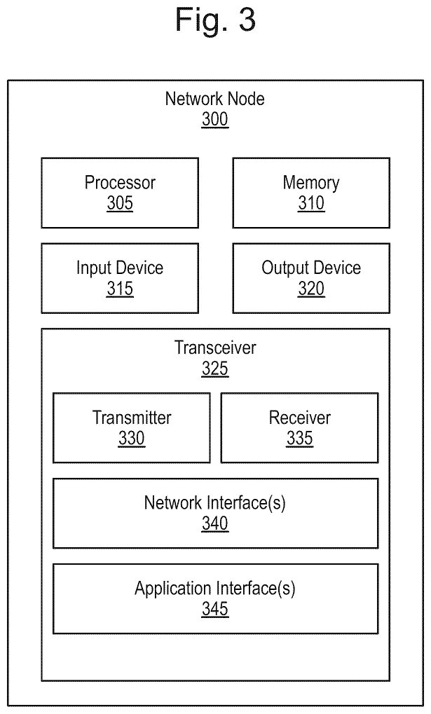

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise a first network node, an ambient IoT function 425, 525, 625 and/or a base station 410, 510, 610 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

The “Ambient power-enabled Internet of Things” may comprise “ambient IoT” devices that are able to communicate with mobile networks, such as legacy wireless communication networks, 5G networks and beyond. An “ambient IoT” device is an Internet of Things (IoT) device powered by harvesting energy, such as RF energy, solar energy, wind energy, etc. An ambient IoT device may be battery-less and may have limited energy storage capability (e.g., using an internal capacitor).

RF energy harvesting enables wireless IoT devices to harvest energy from RF signals available in their environment, such as RF signals transmitted from mobile networks or from nearby Wi-Fi networks. RF energy harvesting is a technology that enables self-sustainable wireless IoT networks.

There are presented herein enhancements to 5G networks that enable them to better support Ambient IoT (AIoT) devices. There are described herein mechanisms for onboarding ambient devices in a wireless communication network. There are also described herein mechanisms for managing transmission requirements of ambient devices in a wireless communication network.

It is anticipated that certain research challenges will need to be addressed to enable the large-scale deployment of energy harvesting solutions for IOT environments. There are presented herein new ways to enhance 5G networks for supporting RF energy harvesting in IoT devices. In particular, more opportunities for RF energy harvesting in IoT devices can be provided by increasing the available RF signals in the environment, e.g., by increasing the RF signals transmitted by a 5G network.

3GPP TR 22.840 v 1.0.0 describes use cases and service requirements related to how AIoT devices can be supported in 5G networks. However, this technical report does not consider technical enhancements for supporting AIoT devices; it only addresses use cases and service requirements.

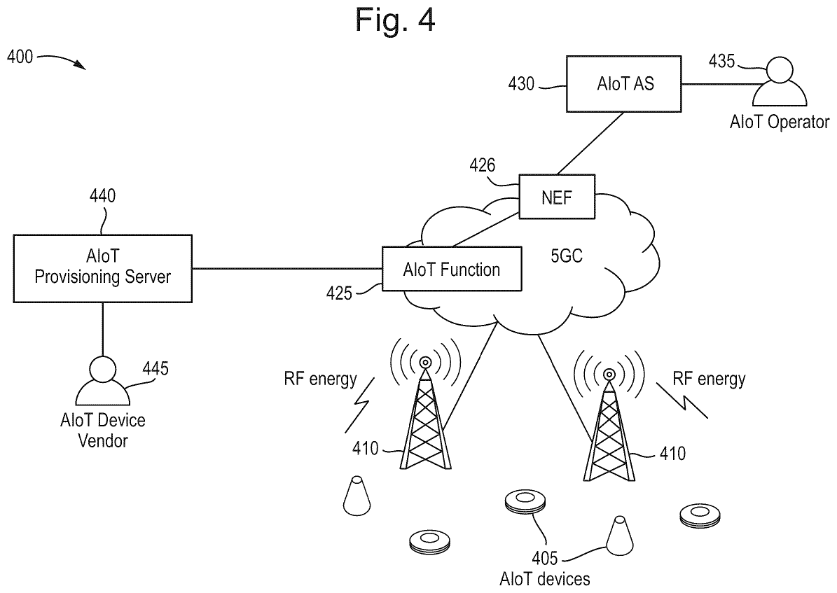

FIG. 4 illustrates a system 400 comprising a wireless communication network that includes a plurality of ambient IoT devices. The system 400 comprises a plurality of ambient IoT devices 405, a plurality of base stations 410 and a 5G core 420. The 5G core 420 includes an AIoT Function 425 and a network exposure function (NEF) 426. The system 400 further comprises an AIoT application function implemented by way of an AIoT application server (AIoT AS) 430 which communicates with the NEF 426 and an AIoT Operator 435. The system 400 further comprises an AIoT provisioning function implemented by way of an AIoT provisioning server (AIoT PS) 440 which communicates with the AIoTF 425 and an AIoT Device Vendor 445.

The AIoT Operator 435 (which may also be known as a Vertical Operator), is the entity that owns one or more AIoT devices 405 and deploys these AIoT devices in the field. The AIoT operator 435 buys, leases, or in some way acquires one or more AIoT devices 405 from the AIoT device vendor 445. The AIoT operator 435 maintains the AIoT Application Server (AIoT AS) 430, which communicates with one or multiple 5G networks via respective one or multiple Network Exposure Functions (NEFs) 426 in each 5G network. Herein, we consider communication with only one 5G network for simplicity. However, the aspects presented in this disclosure can be readily extended to enable communication between an AIoT AS 430 and multiple 5G networks.

The AIoT operator 435 makes an agreement with a 5G network operator (or with multiple 5G network operators). These parties agree that the 5G network shall enable the AIoT devices 405 deployed by the AIoT operator 435 to communicate with the AIoT AS 430 of the AIoT operator 435.

The “AIoT Device Vendor” 445 is the supplier of the AIoT devices 405 and is likely to be the manufacturer of the AIoT devices 405.

The “AIoT Provisioning Server” (AIPS) 440 is a network function arranged to store the AIoT device manufacturing information as provided by the “AIoT Device Vendor” 445; and also to validate the authenticity of an AIoT device 405. As such, the AIPS 440 may operate to assist the 5G network operations with respect to the AIoT related procedures.

The “AIoT Function” (AIoTF) 425 is a new network function (NF) in the 5G core network architecture. The AIoTF 425 implements the necessary functionality in order to enable the 5G network to support communication with the AIoT devices 405.

The 5G network includes a 5G Core (5GC) network 420 and a 5G radio access composed of multiple base stations 410, referred to as gNBs or eNBs. As presented herein, the 5GC 420 architecture is enhanced to support the new network function: AIoTF 425.

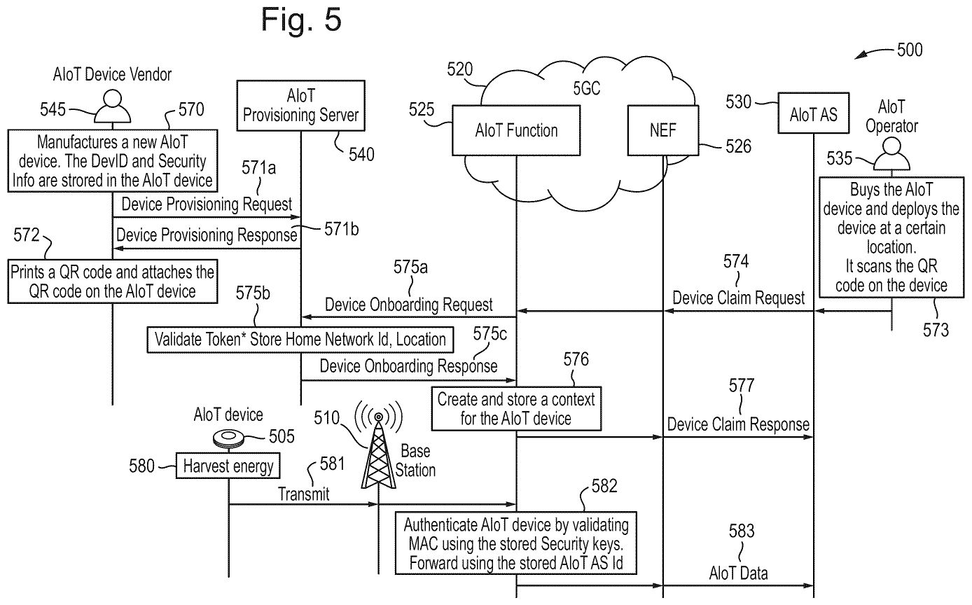

FIG. 5 illustrates a method 500 for onboarding an ambient IoT device. The method 500 is implemented by an ambient IoT device 505, a plurality of base stations 510 and a 5G core 520. The 5G core 520 includes an AIoT Function 525 and a network exposure function (NEF) 526. The system 500 further comprises an AIoT application function implemented by way of an AIoT application server (AIoT AS) 530 which communicates with the NEF 526 and an AIoT Operator 535. The system 500 further comprises an AIoT provisioning function implemented by way of an AIoT provisioning server (AIoT PS) 540 which communicates with the AIoTF 525 and an AIoT Device Vendor 545.

The method 500 is suitable for onboarding an AIoT device in a 5G network. The onboarding procedure for an AIoT device is required for configuring the 5G network with device-specific information (also referred to as AIoT Device Context) that enables the network to support communication for this device. For simplicity, only the important messages are discussed below while other messages which are not important for explaining the method are skipped.

The method 500 enables onboarding of a device in a 5G network without the 5G network having subscription data for this device. Herein, the term onboarding is used to reference making the ambient IoT device able to communicate using the 5G network.

For simplicity, the method 500 presents the steps involved in onboarding a single AIoT device 505. However, it is noted that similar steps can be applied for onboarding a plurality (or a group) of AIoT devices.

At 570, the AIoT device vendor 545 manufactures a new AIoT device 505. Information stored in the AIoT device 505 contains its own unique device identifier (DevID) and Security information, including security keys.

At 571a, the AIoT device vendor 545 sends a “Device Provisioning Request” message towards the AIoT Provisioning Server (AIPS) 540. This message securely stores device-relevant information in the AIPS 540. The AIPS 540 may be equipped with a highly secured storage medium, in which the device-relevant information is stored. All messages to and from the AIPS 540 may be confidentiality and integrity protected with known means.

The “Device Provisioning Request” message contains the “DevID”, the “Security Info” and the device profile (“Dev profile”) of the AIoT device 505. The “Dev profile” of the AIoT device 505 includes device characteristics, i.e., if the device is designed to only transmit (Tx-only), if the device is capable of transmitting and receiving (Tx-Rx), the energy harvesting capabilities of the device, etc.

At 571b, the AIoT Provisioning Server (AIPS) 540 sends a “Device Provisioning Response” message back to the AIoT device vendor 545. This message contains an identity of the AIPS 540 (AIPS Id) and a Token, which can be a randomly generated value associated with this device. In one example the AIPS Id is a Fully Qualified Domain Name (FQDN) for the AIPS 540, which can be resolved to an IP address using the Domain Name Service (DNS).

At 572, once the AIoT device vendor 545 receives the “Device Provisioning Response” message containing the Token and AIPS Id, they print a QR code which contains:
the device identifier (DevID),
the AIoT Provisioning Server Identifier (AIPS Id) of the AIPS, which stores the information of the AIoT device, and
the “Token” received from AIoT device vendor by AIPS.

The AIoT device vendor 545 attaches this QR code to the AIoT device itself. Note that the use of QR code to transfer device-related information is only one example of how this information can be presented. Other means can be used for providing this information from the AIoT device vendor to the AIoT Operator, e.g., sending this information in a data file, in an email, etc.

At 573, the AIoT operator 535 (aka “Vertical”) acquires the AIoT device 505 and, after scanning the QR code, which is present on the AIoT device, deploys the device at a certain location.

At 574, the AIoT AS 530 sends a “Device Claim Request” message to the Network Exposure Function (NEF) of the 5G network. This message is sent after the AIoT Operator 535 provides to the AIoT AS 530 the device information obtained from the QR code.

The “Device Claim Request” message contains AIoT device 505 information including the DevID (Step 571a), the AIPS Id (Step 571b), the Token (Step 571b), the Location where the AIoT device 505 has been deployed and an identifier of the AIoT Application Server 530 (AIoT AS Id) used by the AIoT operator 535. In other scenarios, the “Device Claim Request” message can contain information, not only for a single AIoT device 505, but for a plurality (or a group) of AIoT devices 505.

The NEF 526 authenticates the “Device Claim Request” message (with existing means not detailed here) and then relays this message to an AIoTF 525 in the 5G core network 520. If there are multiple AIoTFs deployed in the 5G core network, the NEF 526 selects one of them by using the information in step 574. For example, the AIoTF 525 may be selected by using one or more of the following parameters in the “Device Claim Request” message: AIPS Id, Location, AIoT AS Id.

At 575a, the AIoT Function (AIoTF) in the 5G network initiates the AIoT device onboarding procedure by sending a “Device Onboarding Request” message to the AIPS 540. The contact information (e.g., the IP address) of the AIPS 540 can be derived by using the AIPS Id received in step 574.

The “Device Onboarding Request” message contains the DevID and the Token received in step 574, as well as the identity of the 5G network, referred to as the “Home Network Id”. The Token information in step 575a can be the same as the Token received in step 574 or another value derived (e.g., using a hash function) from the Token in step 574. In the latter case, the Token is presented as a hashed Token (Token*).

At 575b, the AIPS 540, upon receiving the “Device Onboarding Request” message by the AIoTF 525, validates the received Token (or hashed token (Token*)), i.e., it determines whether it matches the Token value securely stored in the AIPS 540 for this ambient IoT device 505. The AIPS 540 stores the received Home Network Id and proceeds to step 575c when Token validation is successful, or rejects the received request when the Token validation is unsuccessful.

At 575c, the AIPS 540 sends a “Device Onboarding Response” message to the AIoTF 525 of the 5G network, which contain the device information that is securely stored in the AIPS 540. The “Device Onboarding Response” message contains the “Security Info” and the “Dev profile” of the AIoT device 505 (this information has been made available to the AIPS 540 in Step 571a).

At step 576, the AIoTF 525, upon receiving a successful “Device Onboarding Response” message from AIPS 540, creates and stores an AIoT Device Context for the relevant AIoT device 505. This AIoT Device Context contains various information for the AIoT device 505 including the DevID, the Token, the Security Info, the Dev profile, the Location of the AIoT device 505, the AIoT AS Id, etc.

At step 577, the AIoTF 525 of the 5G network 520, sends (through NEF 526) a “Device Claim Response” message back to the AIoT AS 530. The “Device Claim Response” message encapsulates a “Success” or “Failure” indication that denotes the outcome of the device claiming procedure. Note that with this device claiming procedure (steps 574 to 577) the AIoT AS 530 claims ownership of the AIoT device 505 and instructs the 5G network 520 to forward all subsequent messages from this AIoT device 505 to the AIoT AS 530.

From this point onwards, once the “Device Claim Response” message (received from the AIoT AS in step 577) encapsulates a “Success” indication, the AIoT device 505 can exchange information with the AIoT AS 530, via the 5G network 520, as described below.

At 580, the AIoT device 505 harvests energy e.g., from the RF transmissions of one or more 5G Base Stations (gNBs) 510 or from another sources, such as a WiFi ® network.

At 581, the AIoT device 505, having harvested enough energy to operate, transmits an uplink message which is received by a gNB (or multiple gNBs) 510 and is forwarded to the AIoTF 525. This uplink message encapsulates the DevID, a “Payload” and a “Message Authentication Code” (MAC). The MAC has been created using the security information stored in the AIoT device (see step 0) and the “Payload”. For example, the MAC can be derived as HashFunctionType(security key, “Payload”), where the HashFunctionType and the security key are part of the security information stored in the AIoT device 505 and in the AIoTF 525 (received in step 575c).

At 582, the AIoTF 525 receives the uplink message transmitted by the AIoT device 505 (via one or more gNBs 510) and examines the validity of the MAC value in this message, i.e., it derives its own MAC value using the device information stored in the AIoTF 525 (e.g., again using HashFunction Type(security key, “Payload”)) and examines whether the MAC value created by AIoTF 525 matches the received MAC from the AIoT 505. If they match, the received uplink message is considered authentic and the AIoTF 525 proceeds to the next step. If they don't match, the AIoTF 525 discards the received uplink message.

At 583, the AIoTF 525 sends (via NEF 526) an “AIoT Data” message to the AIoT AS 530. The identity of the AIoT AS 530 is retrieved from the stored AIoT device context. The “AIoT Data” message encapsulates the DevID and the Payload of the message transmitted by the AIoT device 505.

Note that the Payload may be encrypted and in that case only the AIoT AS 530 can decrypt this message using App-layer security information. This security information is not provided to the 5G network 520, i.e., it is different from the security information provided by AIPS in step 575c. Hence, the 5G network 520 cannot interpret the app-layer information exchanged between the AIoT device 505 and its associated AIoT AS 530. However, the 5G network 520 can validate the authenticity of the received uplink messages, as explained above.

A slight variation of the method 500 comprises using an Ambient IoT Blockchain Network (AIBN) instead of an Ambient IoT Provisioning Server (AIPS) 540. In a similar way as described for AIPS 540, the AIBN stores the AIoT device manufacturing information provided by the “AIoT Device Vendor” 545, as a record in the blockchain's distributed ledger. With its immutable records, the AIBN introduces an additional level of security and transparency, further ensuring that records pertaining to the AIoT device 505 in the distributed ledger cannot be altered or tampered in a fraudulent way, and that in such cases the event will be recorded in the form of a transaction, transparent to all blockchain network members. When an AIBN is utilized, all the steps described above for AIPS 540 remain substantially the same. The only difference is that the “Ambient IoT Provisioning Server identifier” (AIPS Id) is not required and a well-known blockchain is used instead. In case the blockchain is a general-purpose blockchain (e.g., the Ethereum blockchain) and a Smart Contract is deployed for performing the functionality of the AIPS 540, then a Smart Contract identifier can be used in Steps 571b, 572 and 574.

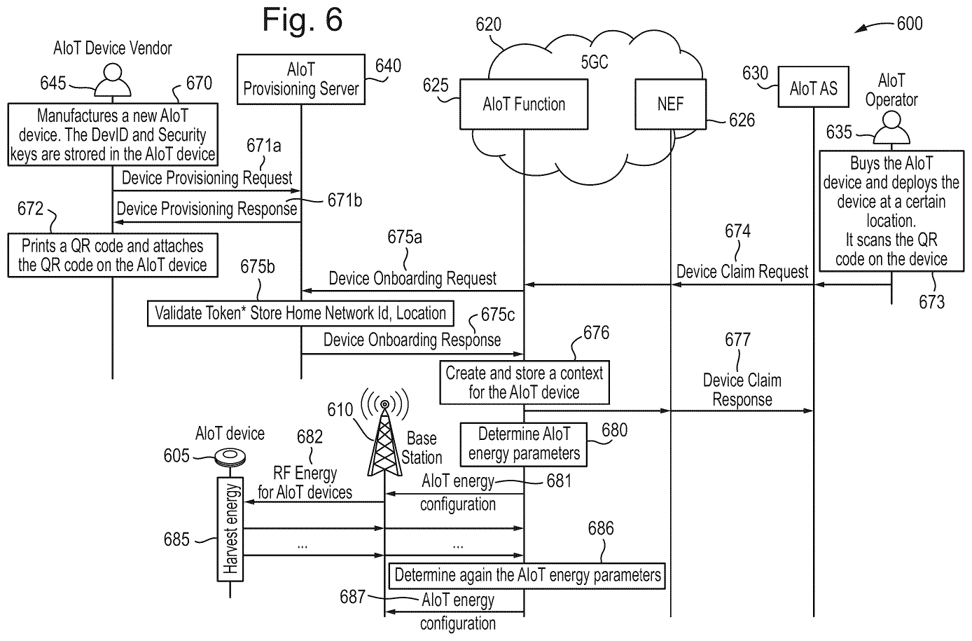

FIG. 6 illustrates a method 600 for managing transmission requirements of an ambient IoT device. The method 600 is implemented by an ambient IoT device 605, a plurality of base stations 610 and a 5G core 620. The 5G core 620 includes an AIoT Function 625 and a network exposure function (NEF) 626. The system 600 further comprises an AIoT application function implemented by way of an AIoT application server (AIoT AS) 630 which communicates with the NEF 626 and an AIoT Operator 635. The system 600 further comprises an AIoT provisioning function implemented by way of an AIoT provisioning server (AIoT PS) 640 which communicates with the AIoTF 625 and an AIoT Device Vendor 645.

Method 600 concerns the support of transmission (Tx) Requirements, i.e., it enables the AIoT operator 635 to specify a desired message transmission rate for an AIoT device 605 or for a group of AIoT devices 605. Method 600 may be used in conjunction with method 500. Alternatively, method 600 may be employed once an AIoT device 605 has been onboarded using a method different to method 500. For ease of explanation, method 600 is illustrated being implemented with an onboarding process according to method 500.

Steps 670 to 673 are performed in accordance with steps 570 to 573 described above in connection with method 500 of FIG. 5.

Step 674 is performed as per step 574, except here the AIoT operator 635 additionally indicates transmission requirements (Tx Requirements) indicating the number of messages that the AIoT device 605 should preferably transmit during a given time period. For example, it may include a “Tx Requirements” parameter indicating that the AIoT device 605 should preferably send 5 messages per day. Since the AIoT device 605 relies on harvested energy without an external power supply, it can transmit only after harvesting enough energy. When the 5G network 620 determines that the AIoT device 605 does not transmit as many times as required by the “Tx Requirements” parameter, it might increase the power emitted by the gNB(s) in the location of the AIoT device 605 in order to assist the device harvest more energy and increase the number of transmissions.

Steps 675a to 675c are performed in accordance with steps 575a to 575c described above in connection with method 500 of FIG. 5.

At step 676, the “Device Context” which is created and stored by the AIoTF 625 additionally includes also the “Tx Requirements” parameter (indicated by the AIoT operator 635 via the AIoT AS 630 in Step 674).

Step 677 is performed in accordance with step 577 described above in connection with method 500 of FIG. 5.

At step 680, the AIoTF 625 determines AIoT energy parameters for the gNB 610 serving the location of the AIoT device 605. The AIoT energy parameters are derived based on the Tx Requirements of the considered AIoT device 605. These may also be based on the Tx Requirements of a plurality of other AIoT devices 605 served by the same AIoT-capable gNB 610. The AIoT energy parameters indicate to a gNB 610 how to modify its RF transmissions and provide more or less energy for harvesting by nearby AIoT devices 605. As an example, e.g., the AIoT energy parameters may indicate to gNB 610 to increase or decrease the power or the rate of its RF transmissions, which supply energy to nearby AIoT devices 605.

Note that, since the AIoTF 625 cannot know how much RF energy the AIoT device 605 can harvest (because it cannot know the exact amount of RF energy reaching the device), the AIoTF 625 can only provide a rough estimation of the AIoT energy parameters for the respective gNB 610. After observing the number of transmissions performed by the AIoT device 605 (and possibly all other AIoT devices in the vicinity of the gNB 610), the AIoTF 625 can adjust the provided AIoT energy parameters accordingly.

At 681, the AIoTF 625 sends an “AIoT energy configuration” message to the AIoT-capable gNB 610 serving the AIoT device 605. This message carries the AIoT energy parameters determined in step 680. In other words, the “AIoT energy configuration” message contains energy configuration instructions, which indicate to gNB 610 how to alter the amount of transmitted RF energy that is harvested by nearby AIoT devices 605, in order to fulfil the requested Tx Requirements of the AIoT device 605.

At step 682, the gNB 610 which has received the “AIoT energy configuration” message, transmits an amount of “RF Energy for AIoT devices” that is adjusted according to the received AIoT parameters received in step 681. The “RF Energy for AIoT devices” is an RF signal or a combination of RF signals using a specific frequency band which are harvested by the AIoT devices 605 in the vicinity of the gNB 610.

At step 685, the AIoT device 605 harvests energy from the “RF Energy for AIoT devices” emitted by the gNB 610. Every time the AIoT device 605 harvests enough energy, it wakes up and performs a transmission of an uplink message, which contains a Payload that is forwarded to an AIoT AS, as illustrated in method 500 of FIG. 5, steps 581 to 583.

At 686, the AIoTF 625 determines again new AIoT energy parameters for the gNB 610 by observing the number of transmissions made by the AIoT devices 605 in the vicinity of the gNB 610 and by comparing this number with the preferred number of transmissions of each AIoT device 605. For example, if the AIoTF 625 determines that some AIoT devices 605 fail to satisfy their Tx Requirements, the AIoTF 625 will derive new AIoT energy parameter that will cause the gNB 610 to increase the transmitted “RF Energy for AIoT devices”.

At 687, the AIoTF 625 sends again an “AIoT energy configuration” message to the AIoT-capable gNB 610 (as in step 681) to provide the updated/new AIoT energy parameters determined in the previous step (686).

The flow described in steps 681 to 687 is repeated periodically in an effort to fulfil the AIoT device preferable Tx Requirements set by the AIoT Operator 635 given in step 674. However, it cannot be guaranteed that the Tx Requirements of an AIoT device 605 will be met because the AIoT device 605 may never be able to harvest enough RF energy due to detrimental communication conditions, such as poor radio channel conditions. However, the steps described herein tend to bring the rate of transmission at least closer to a desired rate.

Accordingly, there is provided a first network node for wireless communication, comprising a processor; and a memory coupled with the processor. The processor is configured to cause the first network node to: receive a plurality of uplink messages from an ambient IoT device; and determine whether the rate of receipt of messages from the ambient IoT device is within a preferred threshold range. The processor is further configured to cause the first network node to: determine energy parameters for a base station that serves the ambient IoT device, the energy parameters determined for optimizing energy harvesting by the ambient IoT device, wherein a measure of the energy harvesting by the ambient IoT device is given by the determination as to whether the rate of receipt of messages from the ambient IoT device is within the preferred threshold range; and send an energy configuration message to the base station, the energy configuration message comprising the determined energy parameters.

The first network node is thus arranged to modify radio frequency transmissions in a wireless communications network so as to optimize an amount of power made available to the ambient IoT device. The first network node may comprise an ambient IoT Function. The ambient IoT Function may reside in a 5G core. Ambient IoT refers to ambient power-enabled Internet of Things.

The processor may be further configured to cause the first network node to: determine initial energy parameters for a base station that serves an ambient IoT device; and send an energy configuration message to the base station, the energy configuration message comprising the determined initial energy parameters. The initial energy parameters may comprise default energy parameters suitable for providing energy to an ambient IoT device from a base station.

The uplink messages may be received via the base station. The base station may be a gNB.

The processor may be configured to cause the first network node to receive, from an application function, a preferred threshold range of the rate of receipt of messages from the ambient IoT device. The preferred threshold range may comprise a number of messages per day. For example, the preferred threshold range may comprise three messages per day. The preferred threshold range is associated with (or determines) the amount of energy that is required to be harvested by the ambient IoT device.

The energy parameters may comprise an indication of power, or rate, or both of radio frequency transmissions by the base station. The base station that serves the ambient IoT device may provide the radio frequency transmissions that supplies energy to the ambient IoT device.

If the rate of receipt of messages from the ambient IoT device is below the preferred threshold range, then the determined energy parameters may indicate an increase in power, or rate, or both of radio frequency transmissions by the base station. However, if the rate of receipt of messages from the ambient IoT device is above the preferred threshold range, then the determined energy parameters may indicate a decrease in power, or rate, or both of radio frequency transmissions by the base station.

The processor may be further configured to cause the first network node to schedule the claimed operations to be performed on a periodic basis. For example, the method may be performed daily, hourly, or every six hours.

A plurality of uplink messages may be received from a plurality of ambient IoT devices via the base station, and determining whether the rate of receipt of messages from the ambient IoT device is within a preferred threshold range may comprise determining whether an average of the preferred rate of receipt of messages from the plurality of ambient IoT devices is within a preferred threshold range.

A plurality of uplink messages may be received from a plurality of ambient IoT devices via the base station, and determining whether the rate of receipt of messages from the ambient IoT device is within a preferred threshold range may comprise determining whether the rate of receipt of messages from each of the plurality of ambient IoT devices is within a respective preferred threshold range.

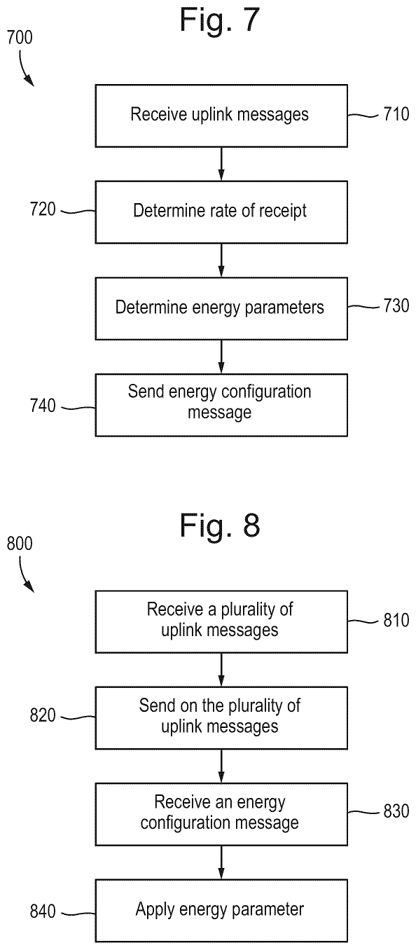

FIG. 7 illustrates a method 700 in a first network node. The method 700 comprises: receiving 710 a plurality of uplink messages from an ambient IoT device; and determining 720 whether the rate of receipt of messages from the ambient IoT device is within a preferred threshold range. The method 700 further comprises determining 730 energy parameters for a base station that serves the ambient IoT device, the energy parameters determined for optimizing energy harvesting by the ambient IoT device, wherein a measure of the energy harvesting by the ambient IoT device is given by the determination as to whether the rate of receipt of messages from the ambient IoT device is within the preferred threshold range; and sending 740 an energy configuration message to the base station, the energy configuration message comprising the determined energy parameters.

In certain embodiments, the method 700 may be performed by a processor executing program code, for example, a microcontroller, a microprocessor, a CPU, a GPU, an auxiliary processing unit, a FPGA, or the like.

The first network node is thus arranged to modify radio frequency transmissions in a wireless communications network so as to optimize an amount of power made available to the ambient IoT device. The first network node may comprise an ambient IoT Function. The ambient IoT Function may reside in a 5G core. Ambient IoT refers to ambient power-enabled Internet of Things.

The method may further comprise: determining initial energy parameters for a base station that serves an ambient IoT device; and sending an energy configuration message to the base station, the energy configuration message comprising the determined initial energy parameters. The initial energy parameters may comprise default energy parameters suitable for providing energy to an ambient IoT device from a base station.

The uplink messages may be received via the base station. The base station may be a gNB.

The method may further comprise receiving, from an application function, a preferred threshold range of the rate of receipt of messages from the ambient IoT device. The preferred threshold range may comprise a number of messages per day. The preferred threshold range may comprise three messages per day. The preferred threshold range is associated with (or determines) the amount of energy that is required to be harvested by the ambient IoT device.

The energy parameters may comprise an indication of power, or rate, or both of radio frequency transmissions by the base station. The base station that serves the ambient IoT device may provide the radio frequency transmissions that supply energy to the ambient IoT device.

If the rate of receipt of messages from the ambient IoT device is below the preferred threshold range, then the determined energy parameters may indicate an increase in power, or rate, or both of radio frequency transmissions by the base station.

If the rate of receipt of messages from the ambient IoT device is above the preferred threshold range, then the determined energy parameters may indicate a decrease in power, or rate, or both of radio frequency transmissions by the base station.

The method may be scheduled to be performed on a periodic basis. For example, the method may be performed daily, hourly, or every six hours.

A plurality of uplink messages may be received from a plurality of ambient IoT devices via the base station, and determining whether the rate of receipt of messages from the ambient IoT device is within a preferred threshold range may comprise determining whether an average of the preferred rate of receipt of messages from the plurality of ambient IoT devices is within a preferred threshold range.

A plurality of uplink messages is received from a plurality of ambient IoT devices via the base station, and determining whether the rate of receipt of messages from the ambient IoT device is within a preferred threshold range comprises determining whether the rate of receipt of messages from each of the plurality of ambient IoT devices is within a respective preferred threshold range.

There is further provided a base station for wireless communication, comprising a processor, and a memory coupled with the processor. The processor is configured to cause the base station to: receive a plurality of uplink messages from an ambient IoT device; and send the plurality of uplink messages to a first network node in the wireless communication network. The processor is further configured to cause the base station to: receive an energy configuration message from the first network node, the energy configuration message comprising at least one energy parameter; and transmit radio frequency signals in accordance with the at least one energy parameter, the radio frequency signals transmitted to supply energy to the ambient IoT device.

The base station is thus arranged to modify radio frequency transmissions in a wireless communications network so as to optimize an amount of power made available to the ambient IoT device. The base station may be a gNB. The first network node may comprise an ambient IoT Function. The ambient IoT Function may reside in a 5G core. Ambient IoT refers to ambient power-enabled Internet of Things.

The processor may be further configured to cause the base station to receive an initial energy configuration message from the first network node, the energy configuration message comprising initial energy parameters. The initial energy parameters may comprise default energy parameters suitable for providing energy to an ambient IoT device from a base station. The energy parameters may comprise an indication of power, or rate, or both of radio frequency transmissions by the base station.

If the rate of receipt of messages from the ambient IoT device is below a preferred threshold range, then the determined energy parameters may indicate an increase in power, or rate, or both of radio frequency transmissions by the base station. Alternatively, if the rate of receipt of messages from the ambient IoT device is above a preferred threshold range, then the determined energy parameters may indicate a decrease in power, or rate, or both of radio frequency transmissions by the base station.

The preferred threshold range may comprise a number of messages per day. The preferred threshold range may comprise three messages per day. The preferred threshold range of the rate of receipt of messages from the ambient IoT device may be set by an application function. The application function may be implemented as an application server. The application function may comprise an ambient IoT application server.

FIG. 8 illustrates a method 800 in a base station in a wireless communication network. The method 800 comprises: receiving 810 a plurality of uplink messages from an ambient IoT device; and sending 820 the plurality of uplink messages to a first network node in the wireless communication network. The method 800 further comprises receiving 830 an energy configuration message from the first network node, the energy configuration message comprising at least one energy parameter; and transmitting 840 radio frequency signals in accordance with the at least one energy parameter, the radio frequency signals transmitted to supply energy to the ambient IoT device.

In certain embodiments, the method 800 may be performed by a processor executing program code, for example, a microcontroller, a microprocessor, a CPU, a GPU, an auxiliary processing unit, a FPGA, or the like.

The base station is thus arranged to modify radio frequency transmissions in a wireless communications network so as to optimize an amount of power made available to the ambient IoT device. The base station may be a gNB. The first network node may comprise an ambient IoT Function. The ambient IoT Function may reside in a 5G core. Ambient IoT refers to ambient power-enabled Internet of Things.

The method may further comprise receiving an initial energy configuration message from the first network node, the energy configuration message comprising initial energy parameters. The initial energy parameters may comprise default energy parameters suitable for providing energy to an ambient IoT device from a base station. The energy parameters may comprise an indication of power, or rate, or both of radio frequency transmissions by the base station.

If the rate of receipt of messages from the ambient IoT device is below a preferred threshold range, then the determined energy parameters may indicate an increase in power, or rate, or both of radio frequency transmissions by the base station. The threshold range may be defined as a number of messages per time period. The threshold range may be defined as a number of messages per day. The preferred threshold range may comprise three messages per day. The preferred threshold range of the rate of receipt of messages from the ambient IoT device may be set by an application function. The application function may be implemented as an application server. The application function may comprise an ambient IoT application server.

If the rate of receipt of messages from the ambient IoT device is above a preferred threshold range, then the determined energy parameters may indicate a decrease in power, or rate, or both of radio frequency transmissions by the base station.

The preferred threshold range may comprise a number of messages per time period. The preferred threshold range may comprise a number of messages per day. The preferred threshold range may comprise three messages per day. The preferred threshold range of the rate of receipt of messages from the ambient IoT device may be set by an application function. The application function may be implemented as an application server. The application function may comprise an ambient IoT application server.

There are described herein technical enhancements to 5G networks that enable them to support ambient IoT (AIoT) devices.

There is provided herein an AIoT Provisioning Server (AIPS) which stores the AIoT device manufacturing information and validates the authenticity of an AIoT device.

An AIoT Function (AIoTF) is described as a new NF in the 5G CN architecture and is arranged to handle all the AIoT related procedures in the 5G Core network side.

An AIoT Application Server (AIoT AS) is described which collects the AIoT device data transmitted by the AIoT devices.

Alternatively, an AIoT Blockchain Network (AIBN) may be provided to store AIoT device manufacturing information in the blockchain's distributed ledger and validates the authenticity of an AIoT device.

There is described herein an arrangement to facilitate onboarding of an AIoT device into the AIPS via the 5G network.

There are also provided 5G network specific procedures which have been specified in order to enable the proper translation of the Tx Requirements (set by the AIoT Operator), to appropriate network decisions in terms of energy emission through RF signals by the gNBs.

There is provided herein a network node (such as an AIoTF) in a wireless communication network, comprising: a processor; and a memory coupled with the processor, the processor configured to cause the network node to: receive a first request message (step 574 or 674) that requests to enable communication with an ambient IoT device, wherein the first request message contains an identity of the ambient IoT device, a first identity of a provisioning server (AIPS) and a second identity of an ambient IoT server (AIoT AS); retrieves configuration information for the ambient IoT device from the first provisioning server (step 575 or 675); create a context for the ambient IoT device (step 576 or 676) based on the retrieved configuration information and based on information in the first request message; receive a first uplink message from the ambient IoT device (via one or more gNBs) (step 581); validates the authenticity of the first uplink messages using information in the created context (step 582); and forwards the first uplink message upon successful validation of authenticity to the ambient IoT server (step 583). The first request message may additionally comprise a location of the ambient IoT device and a token specific to the ambient IoT device.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A first network node for wireless communication, comprising:
at least one memory; and
at least one processor coupled with the at least one memory and configured to cause the first network node to:
receive a plurality of uplink messages from an ambient Internet of Thing (IoT) device;
determine whether a rate of receipt of messages from the ambient IoT device is within a preferred threshold range;
determine energy parameters for a base station that serves the ambient IoT device, wherein the energy parameters are determined for optimizing energy harvesting by the ambient IoT device, wherein a measure of the energy harvesting by the ambient IoT device is given by the determination as to whether the rate of receipt of messages from the ambient IoT device is within the preferred threshold range; and
send an energy configuration message to the base station, wherein the energy configuration message comprises the determined energy parameters.

2. The first network node of claim 1, wherein the at least one processor is further configured to cause the first network node to:
determine initial energy parameters for the base station that serves the ambient IoT device; and
send an energy configuration message to the base station, wherein the energy configuration message comprises the determined initial energy parameters.

3. The first network node of claim 1, wherein the plurality of uplink messages are received via the base station.

4. The first network node of claim 1, wherein the at least one processor is further configured to cause the first network node to receive, from an application function, a preferred threshold range of the rate of receipt of messages from the ambient IoT device.

5. The first network node of claim 1, wherein the energy parameters comprise an indication of power, or rate, or both, of radio frequency transmissions by the base station.

6. The first network node of claim 1, wherein, if the rate of receipt of messages from the ambient IoT device is below the preferred threshold range, the determined energy parameters indicate an increase in power, or rate, or both, of radio frequency transmissions by the base station.

7. The first network node of claim 1, wherein, if the rate of receipt of messages from the ambient IoT device is above the preferred threshold range, the determined energy parameters indicate a decrease in power, or rate, or both, of radio frequency transmissions by the base station.

8. The first network node of claim 1, wherein the at least one processor is further configured to cause the first network node to send the energy configuration message to the base station on a periodic basis.

9. The first network node of claim 1, wherein a plurality of uplink messages is received from a plurality of ambient IoT devices via the base station, and wherein, to determine whether the rate of receipt of messages from the ambient IoT device is within a preferred threshold range, the at least one processor is configured to cause the first network node to determine whether an average of the preferred rate of receipt of messages from the plurality ambient IoT device is within a preferred threshold range.

10. The first network node of claim 1, wherein a plurality of uplink messages is received from a plurality of ambient IoT devices via the base station, and wherein, to determine whether the rate of receipt of messages from the ambient IoT device is within a preferred threshold range, the at least one processor is configured to cause the first network node to determine whether the rate of receipt of messages from each of the plurality of ambient IoT devices is within a respective preferred threshold range.

11. A method performed by a first network node, the method comprising:
receiving a plurality of uplink messages from an ambient Internet of Things (IoT) device;
determining whether a rate of receipt of messages from the ambient IoT device is within a preferred threshold range;
determining energy parameters for a base station that serves the ambient IoT device, wherein the energy parameters are determined for optimizing energy harvesting by the ambient IoT device, wherein a measure of the energy harvesting by the ambient IoT device is given by the determination as to whether the rate of receipt of messages from the ambient IoT device is within the preferred threshold range; and
sending an energy configuration message to the base station, wherein the energy configuration message comprises the determined energy parameters.

12. The method of claim 11, further comprising:
determining initial energy parameters for the base station that serves the ambient IoT device; and
sending an energy configuration message to the base station, the energy configuration message comprising the determined initial energy parameters.

13.-20. (canceled)

21. A base station for wireless communication, comprising:
at least one memory and
at least one processor coupled with the at least one memory and configured to cause the base station to:
receive a plurality of uplink messages from an ambient Internet of Things (IoT) device;
send the plurality of uplink messages to a first network node;
receive an energy configuration message from the first network node, wherein the energy configuration message comprises at least one energy parameter; and
transmit radio frequency signals based on the at least one energy parameter, wherein the radio frequency signals are transmitted to supply energy to the ambient IoT device.

22. The base station of claim 21, wherein the at least one processor is further configured to cause the base station to:
receive an initial energy configuration message from the first network node, wherein the energy configuration message comprises initial energy parameters.

23. The base station of claim 22, wherein the initial energy parameters comprise an indication of power, or rate, or both, of radio frequency transmissions by the base station.

24. The base station of claim 21, wherein, if a rate of receipt of messages from the ambient IoT device is below a preferred threshold range, determined energy parameters indicate an increase in power, or rate, or both, of radio frequency transmissions by the base station.

25. The base station of claim 21, wherein, if a rate of receipt of messages from the ambient IoT device is above a preferred threshold range, determined energy parameters indicate a decrease in power, or rate, or both, of radio frequency transmissions by the base station.

26. A method performed by a base station, the method comprising:
receiving a plurality of uplink messages from an ambient Internet of Things (IoT) device;
sending the plurality of uplink messages to a first network node in the wireless communication network;
receiving an energy configuration message from the first network node, wherein the energy configuration message comprises at least one energy parameter; and
transmitting radio frequency signals based on the at least one energy parameter.

27. The method of claim 26, wherein the radio frequency signals supply energy to the ambient IoT device.

28. The base station of claim 21, wherein the radio frequency signals supply energy to the ambient IoT device.
